(19) United States
(12) Patent Application Publication
(10) Pub. No.: US 2024/0183514 A1
(43) Pub. Date: Jun. 6, 2024

(54) DISPLAY SWITCHING APPARATUS AND DISPLAY SYSTEM

(71) Applicant: OMRON Corporation, KYOTO (JP)

(72) Inventors: Masayuki SHINOHARA, Kyoto-shi (JP); Yuto MORI, Kyoto-shi (JP); Masao MISHINA, Kyoto-shi (JP); Yutaka OKAYASU, Kyoto-shi (JP)

(73) Assignee: OMRON Corporation, KYOTO (JP)

(21) Appl. No.: 18/463,278

(22) Filed: Sep. 7, 2023

(30) Foreign Application Priority Data
Oct. 21, 2022 (JP) 2022-169262

(51) Int. Cl. F21V 5/00; B60K 35/00

(52) U.S. Cl. CPC F21V 5/007; B60K 35/00; F21W 2106/00

(57) ABSTRACT

A display switching apparatus, switching display images by switching irradiation of lights from light sources (7), includes: a lens array (6) in which lenses are arranged; a display part including pixel regions arranged to include regions through which a light formed by condensing each light emitted from the light sources with each lens of the lens array passes; and a housing (9) holding the display part. A transmittance in each pixel region is set corresponding to a predetermined static pattern, a shape of the display part as viewed in a direction perpendicular to a display surface of the display part is an irregular shape that is not rectangular, and a shape of the housing when viewed in the direction perpendicular to the display surface is the same as or similar to the shape of the display part as viewed in the direction perpendicular to the display surface.

### CROSS-REFERENCE TO RELATED APPLICATION

This application claims the priority benefits of Japanese application no. 2022-169262, filed on Oct. 21, 2022. The entirety of the above-mentioned patent application is hereby incorporated by reference herein and made a part of this specification.

### BACKGROUND

### Technical Field

The disclosure relates to a display switching apparatus and a display system.

### Description of Related Art

Patent Document 1 (Japanese Patent Application Laid-Open No. 2020-184013) discloses a display switching apparatus that switches display images by switching irradiation of lights from a plurality of light source positions. A display part of the display switching apparatus includes a plurality of pixel regions. The pixel regions are arranged to include regions through which a light formed by condensing each of the lights emitted from the plurality of light source positions with each lens of a lens array passes. The transmittance in each of the pixel regions is set corresponding to a predetermined static pattern.

Patent Document 2 (Japanese Patent Application Laid-Open No. 2019-91036) discloses an irregular-shaped liquid crystal display apparatus that includes a triangular liquid crystal panel with acute corners and a triangular backlight unit.

According to the technique described in Patent Document 1, when the information to be displayed has an irregular shape, a portion of the rectangular display screen is used to display the information. However, there arises a problem that the region of the portion not used for display is wasted and occupies more space than necessary.

Further, Patent Document 2 discloses a liquid crystal display that has an irregular shape. Besides the fact that the liquid crystal display is a relatively expensive part, it has a problem that a special drive system is required when the liquid crystal display is configured into an unusual irregular shape, which further increases the cost.

One aspect of the disclosure realizes a display switching apparatus at a relatively low cost, in which the region of the portion not used for display is small even when the information to be displayed has an irregular shape.

### SUMMARY

The display switching apparatus according to one aspect of the disclosure is a display switching apparatus for switching display images by switching irradiation of lights from a plurality of light sources. The display switching apparatus includes: a lens array in which a plurality of lenses are arranged; a display part which includes a plurality of pixel regions arranged to include regions through which a light formed by condensing each of the lights emitted from the plurality of light sources with each of the lenses of the lens array passes; and a housing which holds the display part. A transmittance in each of the pixel regions is set corresponding to a predetermined static pattern, a shape of the display part as viewed in a direction perpendicular to a display surface of the display part is an irregular shape that is not rectangular, and a shape of the housing when viewed in the direction perpendicular to the display surface is the same as or similar to the shape of the display part as viewed in the direction perpendicular to the display surface.

The display switching apparatus according to one aspect of the disclosure is a display switching apparatus for switching display images by switching irradiation of lights from a plurality of light sources. The display switching apparatus includes: a lens array in which a plurality of lenses are arranged; a display part which includes a plurality of pixel regions arranged to include regions through which a light formed by condensing each of the lights emitted from the plurality of light sources with each of the lenses of the lens array passes; and a housing which holds the display part. A transmittance in each of the pixel regions is set corresponding to a predetermined static pattern, and a groove forming region including a plurality of grooves is provided in at least a portion of a region, which faces the light sources, on a wall surface of the housing.

The display system according to one aspect of the disclosure is a display system installed inside a vehicle. The display system includes an image display part which displays an image indicating a mode selected in a driving device of the vehicle that has a plurality of modes, and the image display part includes the above display switching apparatus.

### BRIEF DESCRIPTION OF THE DRAWINGS

(a) of FIG. 1 which is denoted by reference numeral 101 is a schematic top view of the display switching apparatus according to the first embodiment of the disclosure. (b) of FIG. 1 which is denoted by reference numeral 102 is a cross-sectional view taken along the line X1-X1 of the view denoted by reference numeral 101.

FIG. 2 which is denoted by reference numerals 201 and 202 is an enlarged view of the wall surface of the housing of the display switching apparatus.

(a) and (b) of FIG. 3 which are denoted by reference numeral 301 and reference numeral 302 are views showing the optical paths from the light source of the display switching apparatus to the light entering surface of the lens array.

(a) of FIG. 4 which is denoted by reference numeral 401 is a view illustrating crosstalk that occurs when the lens array, the housing, etc. have an irregular shape. (b) of FIG. 4 which is denoted by reference numeral 402 is a light amount distribution diagram showing the result of simulating the light amount distribution along the axis Y1 of the view denoted by reference numeral 401.

FIG. 5 is a simulation result showing the relationship between the antireflection structure provided on the wall surface of the housing and the crosstalk effect ratio.

FIG. 6 is a block diagram of the display system according to the first embodiment of the disclosure.

FIG. 7 is a schematic view showing the basic configuration of the image display part included in the display system.

(a), (b), and (c) of FIG. 8 which are denoted by reference numeral 801, reference numeral 802, and reference numeral 803 are views showing a configuration example of the lens array included in the image display part in FIG. 7, respectively.

FIG. 9 is a diagram showing an example of the state of the lens array condensing lights.

FIG. 10 is a diagram in which the views denoted by reference numeral 1001, reference numeral 1002, reference numeral 1003, and reference numeral 1004 show a switching display example of the display part included in the image display part, respectively.

FIG. 11 is a view showing the correspondence relationship between the display part, the lenses constituting the lens array, and the light sources.

(a) to (d) of FIG. 12 are views showing other shapes of the display part 45 and other display examples of the images displayed by the image display part 10 in the display switching apparatus as a modified example of the display switching apparatus of the first embodiment.

### DESCRIPTION OF THE EMBODIMENTS

The display switching apparatus according to one aspect of the disclosure is a display switching apparatus for switching display images by switching irradiation of lights from a plurality of light sources. The display switching apparatus includes: a lens array in which a plurality of lenses are arranged; a display part which includes a plurality of pixel regions arranged to include regions through which a light formed by condensing each of the lights emitted from the plurality of light sources with each of the lenses of the lens array passes; and a housing which holds the display part. A transmittance in each of the pixel regions is set corresponding to a predetermined static pattern, a shape of the display part as viewed in a direction perpendicular to a display surface of the display part is an irregular shape that is not rectangular, and a shape of the housing when viewed in the direction perpendicular to the display surface is the same as or similar to the shape of the display part as viewed in the direction perpendicular to the display surface.

Conventionally, when the information to be displayed has an irregular shape that is not rectangular, in a display device having a rectangular display screen, a portion of the display screen is used to display the information. In this case, there arises a problem that the region of the portion not used for display is wasted and occupies more space than necessary.

In contrast, according to the above configuration, the display part can have an irregular shape according to the shape of the information to be displayed, and the housing can also have a shape along the shape of the display part. Thus, it is possible to minimize the region of the portion not used for display in the display part, and to minimize the size of the housing.

Also, an image indicating the selected mode can be displayed without using a complicated and expensive display device such as a liquid crystal display, thereby realizing the display switching apparatus at a low cost.

In the above display switching apparatus, a wall surface of the housing is shaped so that the wall surface of the housing does not exist between the plurality of light sources and a light entering surface of an actually used lens used for display on the display part among the lenses constituting the lens array.

According to the above configuration, it is possible to form a structure in which the optical paths from the plurality of light sources to the lens array are not blocked by the wall surface of the housing, which provides a display switching apparatus having a good display part with no display unevenness.

In the above display switching apparatus, a groove forming region including a plurality of grooves is provided in at least a portion of a region, which faces the light sources, on the wall surface of the housing.

The above configuration is capable of suppressing crosstalk in which the light from the light source is reflected by the wall surface of the housing and enters the lens array, thereby improving the display quality in the display part.

The display switching apparatus according to one aspect of the disclosure is a display switching apparatus for switching display images by switching irradiation of lights from a plurality of light sources. The display switching apparatus includes: a lens array in which a plurality of lenses are arranged; a display part which includes a plurality of pixel regions arranged to include regions through which a light formed by condensing each of the lights emitted from the plurality of light sources with each of the lenses of the lens array passes; and a housing which holds the display part. A transmittance in each of the pixel regions is set corresponding to a predetermined static pattern, and a groove forming region including a plurality of grooves is provided in at least a portion of a region, which faces the light sources, on a wall surface of the housing.

The above configuration is capable of suppressing crosstalk in which the light from the light source is reflected by the wall surface of the housing and enters the lens array, thereby improving the display quality in the display part.

In the above display switching apparatus, the grooves in the groove forming region extend in a direction parallel to an optical axis of the lens array from the light sources.

In many cases, the housing has a cylindrical shape with a display part side opening for holding the display part and a light source side opening on the side where the light source is arranged. Here, when the housing is manufactured by injection molding using resin, the resin is filled from the display part side opening or the light source side opening. At this time, according to the above configuration, the grooves are provided along the direction in which the resin is filled, which prevents leakage of the filled resin. Therefore, the above configuration is capable of facilitating the manufacturing and improving the manufacturing yield.

In the above display switching apparatus, the groove forming region is provided in a region, on the wall surface of the housing, which allows a light emitted from the light source to reach a light entering surface of an actually used lens used for display on the display part among the lenses constituting the lens array, assuming that the light is specularly reflected by the wall surface.

The above configuration is capable of reliably preventing the light emitted from the light source from being specularly reflected by the wall surface and reaching the light entering surface of the actually used lens, which further improves the display quality of the display part.

The display system according to one aspect of the disclosure is a display system installed inside a vehicle. The display system includes an image display part which displays an image indicating a mode selected in a driving device of the vehicle that has a plurality of modes, and the image display part includes the above display switching apparatus.

One aspect of the disclosure is capable of realizing a display switching apparatus, in which the region of the portion not used for display is small even when the information to be displayed has an irregular shape.

### First Embodiment

An embodiment (hereinafter also referred to as “this embodiment”) according to one aspect of the disclosure will be described below with reference to the drawings.

The display system of the disclosure is a display system installed inside a vehicle (for example, car or the like). The display system of the disclosure includes an image display part that includes a display switching apparatus of the disclosure, and displays an image indicating a mode (state) of a driving device provided in the vehicle. In this embodiment, an image display part 10 using the display switching apparatus of the disclosure will be described.

### 1. Application Example

First, an example of a scene to which the image display part 10 is applied will be described with reference to FIG. 1 to FIG. 4.

(a) of FIG. 1 which is denoted by reference numeral 101 is a schematic top view of the image display part 10. FIG. 1 shows a microlens array (hereinafter abbreviated as lens array) 6, a light source 7, and a housing 9 in the configuration of the image display part 10. The configuration of the image display part 10 will be described in detail later.

The lens array 6 and the housing 9 have an irregular shape that is not rectangular as viewed from the upper surface of the lens array 6 in the vertical direction. In the example denoted by reference numeral 101, the lens array 6 has a star shape as viewed from the upper surface of the lens array 6 in the vertical direction. The housing 9 also has a star shape as viewed from the upper surface of the lens array 6 in the vertical direction, which is similar to the shape of the lens array 6. A wall surface of the housing 9 is shaped so that the wall surface of the housing 9 does not exist between the light source 7 and a light entering surface of the lens array 6.

(b) of FIG. 1 which is denoted by reference numeral 102 is a cross-sectional view taken along the line X1-X1 of reference numeral 101. Assuming that the light source 7 is arranged in the protrusion Q2 of the star shape at the position of reference numeral 70 shown in the view of reference numeral 101, the optical path 71a to the light entering surface 6a of the lens array 6 in the adjacent protrusion Q3 is blocked by the housing 9 as shown in reference numeral 102. In this embodiment, on the contrary, the light source 7 is arranged near the central portion Q1 of the star shape, as shown in reference numeral 101 of (a) of FIG. 1, so the wall surface of the housing 9 does not block the optical path 71 toward the five protrusions Q2 to Q6 of the star shape. Thus, the light source 7 irradiates the entire area of the light entering surface 6a of the lens array 6 with light.

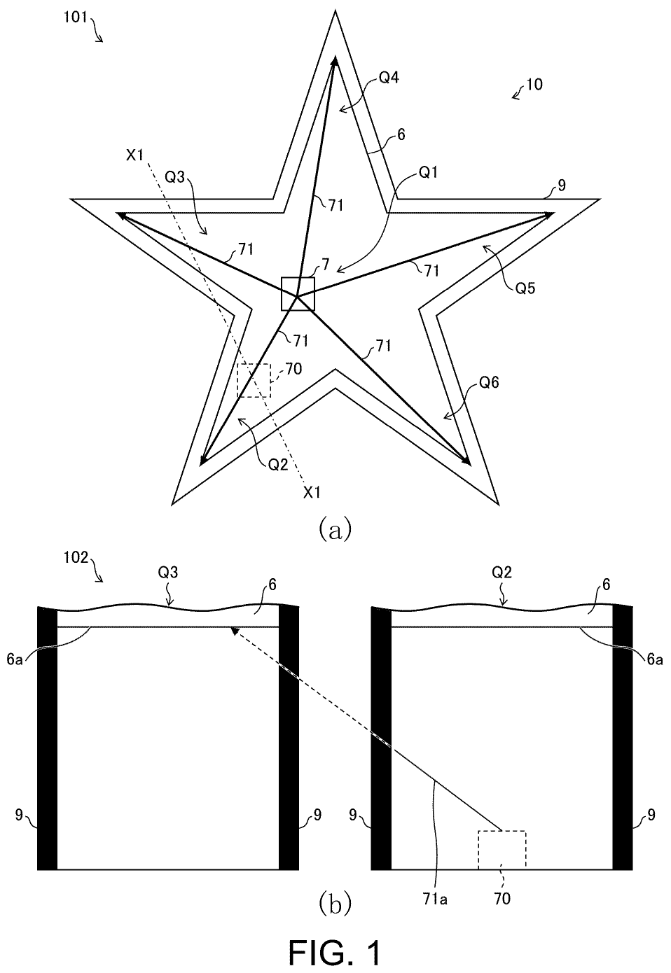

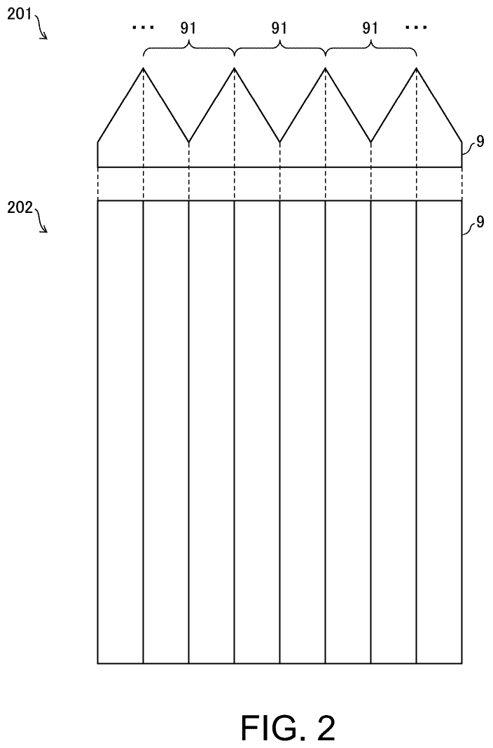

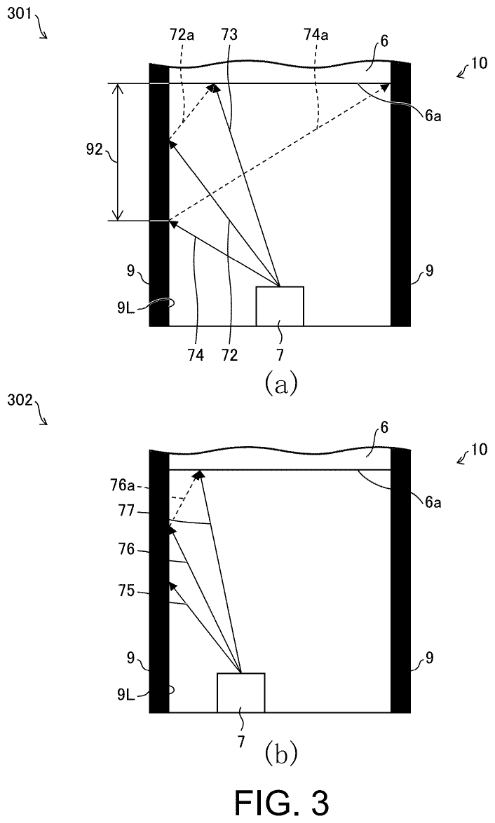

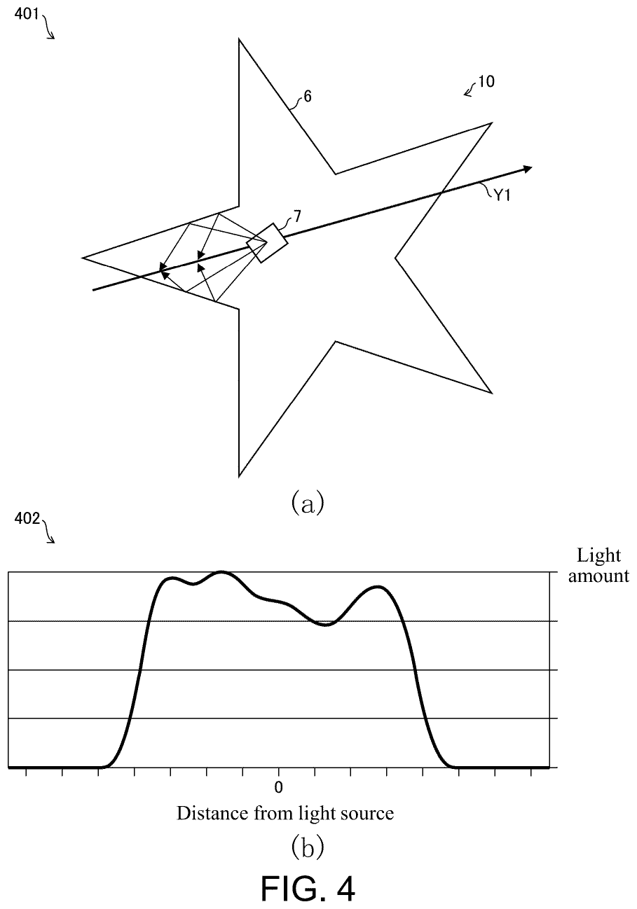

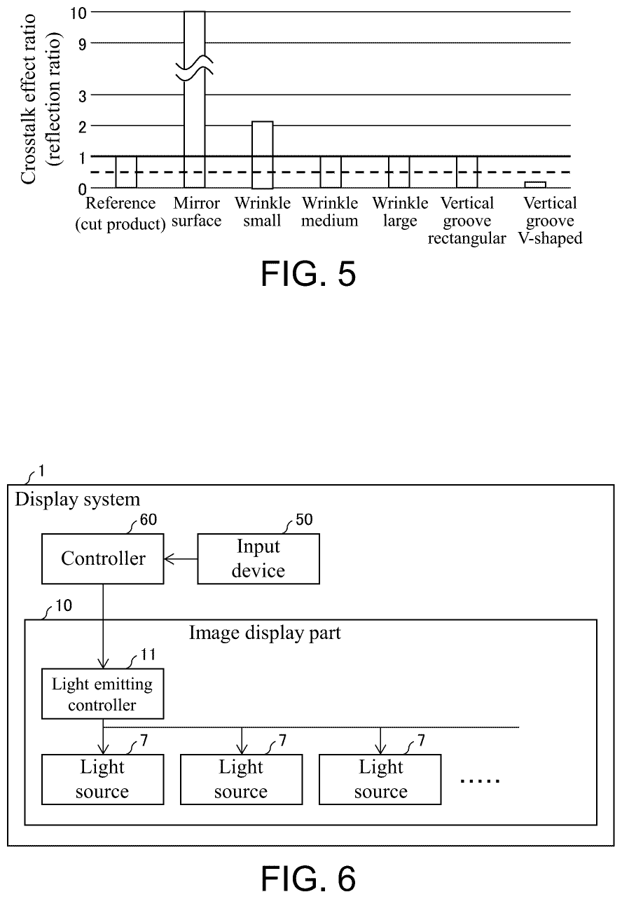

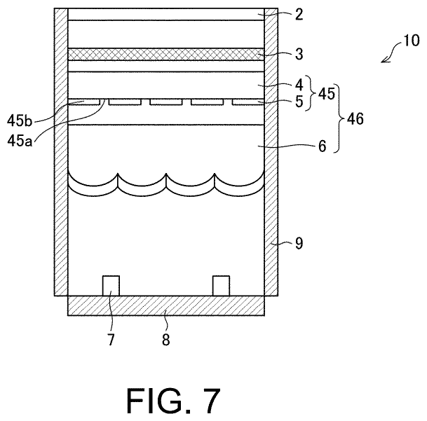

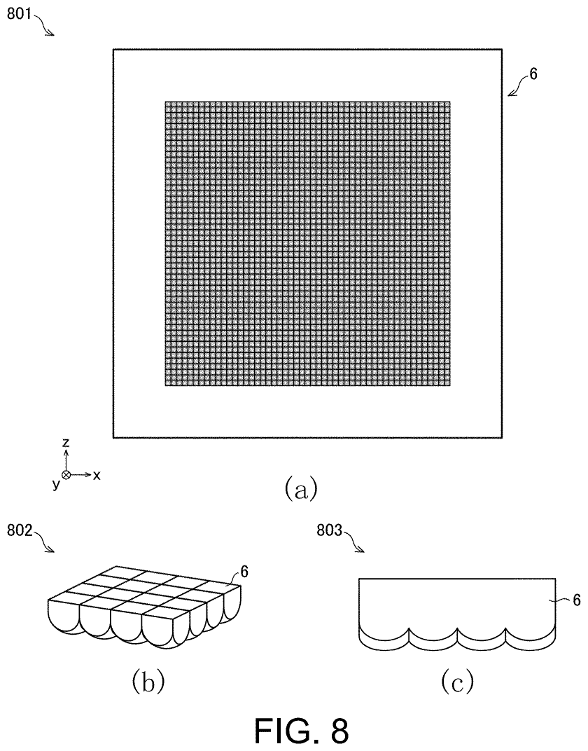

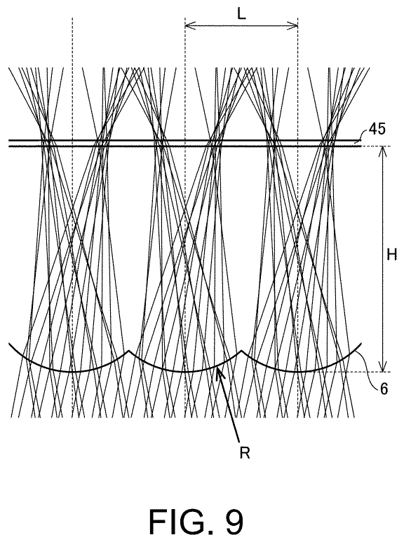

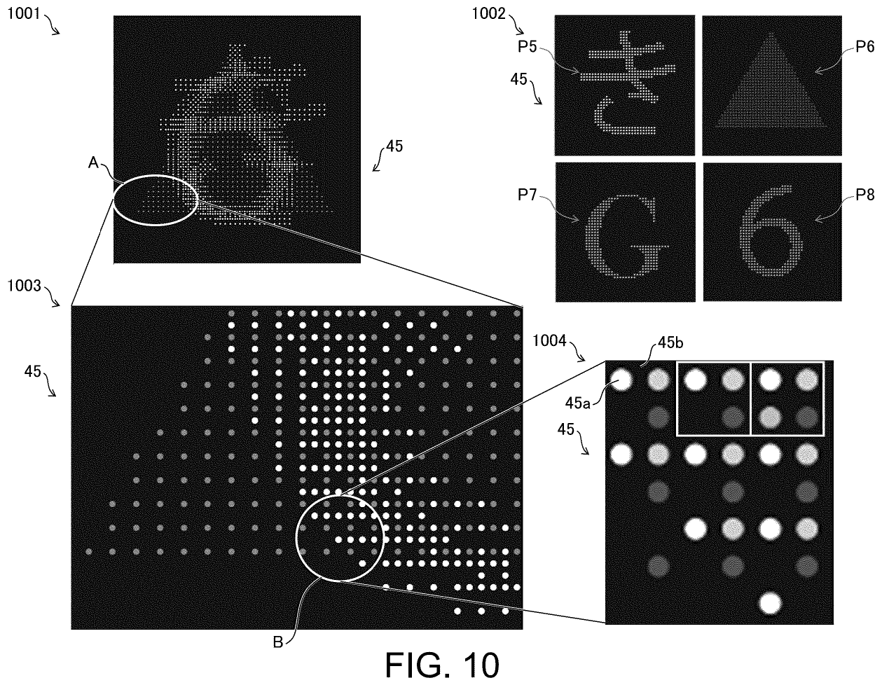

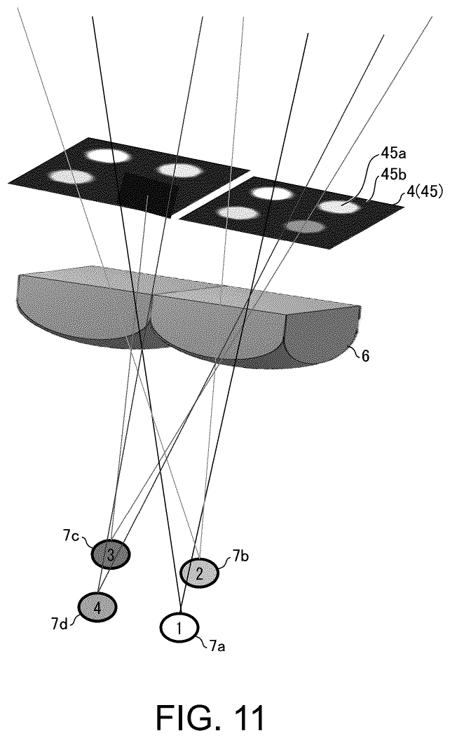

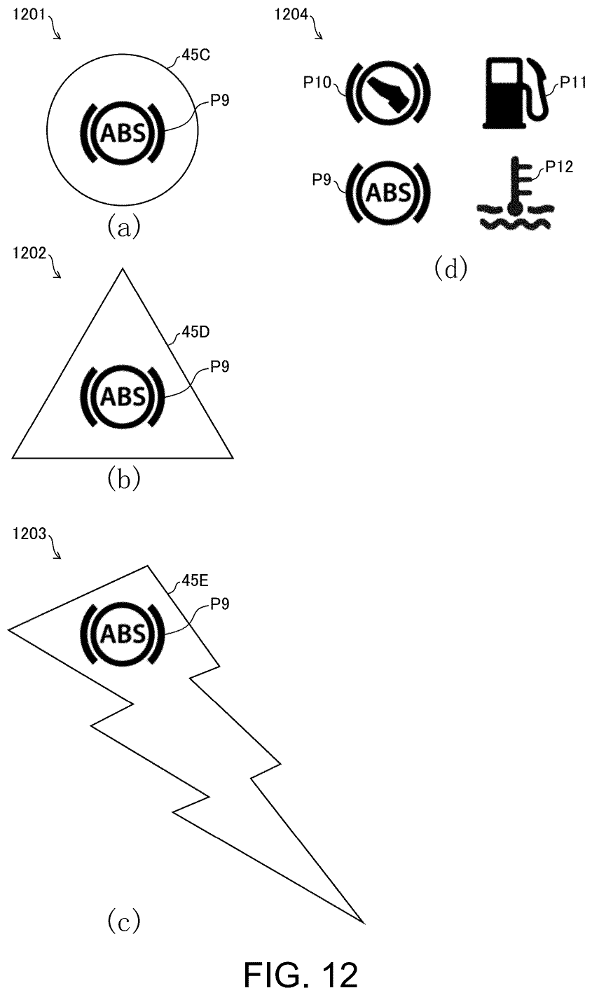

Reference numeral 201 in FIG. 2 is an enlarged view of the wall surface of the housing 9 as viewed from the direction perpendicular to the upper surface of the housing 9. As shown in reference numeral 201, a plurality of V-shaped grooves 91 are formed on the wall surface of the housing 9 in a region facing the light source 7.

Reference numeral 202 in FIG. 2 is an enlarged view of the inner wall surface of the housing 9 as viewed from the inner side of the housing 9. As shown in reference numeral 202, the plurality of grooves 91 extend in a direction parallel to the optical axis direction of the lens array 6 from the light entering surface 6a of the lens array 6 shown in reference numeral 102 of (b) of FIG. 1.

(a) of FIG. 3 which is denoted by reference numeral 301 is a view showing the optical path of the light emitted from the light source 7. (b) of FIG. 3 which is denoted by reference numeral 302 is a view showing the optical path of the light emitted from the light source 7 when the light source 7 is closer to the left wall surface 9L of the housing 9 than in the view of reference numeral 301. The view of reference numeral 301 in (a) of FIG. 3 shows the optical paths 72, 73, and 74 of the light emitted from the light source 7. Assuming that the housing 9 is not provided with the grooves 91 and the light is specularly reflected by the wall surface of the housing 9, the light passing through the optical path 72 is specularly reflected by the wall surface of the housing 9 and reaches the light entering surface 6a of the lens array 6 through the optical path 72a from the same position as the light passing through the optical path 73.

Like the light passing through the optical path 73, the light that directly enters the lens array 6 from the light source 7 is condensed by the lens array 6 and used to display an image. When the light reflected by the wall surface of the housing 9 enters the lens array 6, like the light passing through the optical path 72a, crosstalk can occur, in which an image different from the image that should be displayed becomes visible due to the light.

Besides, the light source 7 has directivity, and has a tendency that the light amount increases as the emission direction becomes closer to the optical axis direction. Assuming that the light source 7 is arranged at a position close to the left wall surface 9L of the housing 9, as shown in reference numeral 302 of (b) of FIG. 3, a large amount of light hits the left wall surface 9L of the housing 9. The view of reference numeral 302 in (b) of FIG. 3 shows the optical paths 75, 76, and 77 of the light emitted from the light source 7. The light passing through the optical path 75 is emitted from the light source 7 in the same direction as the optical path 72 of reference numeral 301. The light passing through the optical paths 76 and 77 is emitted from the light source 7 in a direction closer to the optical axis direction of the lens array 6 than the light passing through the optical path 75 and has a larger light amount than the light passing through the optical path 75. If the housing 9 is not provided with the grooves 91, the light passing through the optical path 76 is specularly reflected by the left wall surface 9L of the housing 9 and reaches the lens array 6 through the optical path 76a from the same position as the light passing through the optical path 77. When a large amount of light is specularly reflected by the wall surface such as the left wall surface 9L of the housing 9 in this way, an image that should not be displayed is displayed more clearly.

In addition, when the lens array 6 and the housing 9 have an irregular shape that is not rectangular as viewed from the upper surface of the lens array 6 in the vertical direction, the light reflected by the inner wall surface of the housing 9 may enter a specific portion of the light entering surface 6a of the lens array 6 in a concentrated manner.

(a) of FIG. 4 which is denoted by reference numeral 401 is a view illustrating crosstalk that occurs when the lens array 6 has an irregular shape. (b) of FIG. 4 which is denoted by reference numeral 402 is a light amount distribution diagram showing the result of simulating the light amount distribution along the axis Y1 of the view denoted by reference numeral 401. In the light amount distribution diagram denoted by reference numeral 402 in (b) of FIG. 4, the horizontal axis represents the distance from the light source 7 and the vertical axis represents the light amount. In reference numeral 401, similar to reference numeral 101 in (a) of FIG. 1, the lens array 6 and the housing 9 have a star shape as viewed from the upper surface of the lens array 6 in the vertical direction. In the light amount distribution diagram of reference numeral 402, the light amount is concentrated in a portion close to the protrusion of the star shape. It is presumed that this is because the wall surfaces of the housing 9 are close to each other in the protrusion of the star shape, and the amount of light reflected by the wall surface and entering the lens array increases.

FIG. 5 is a diagram showing the ratio of the light reflected by the wall surface of the housing 9 to the light entering the lens array 6 as a crosstalk effect ratio. In FIG. 5, a case where no measures such as grooves 91 are applied to the wall surface of the housing 9 is used as a reference, and the crosstalk effect ratio at that time is set to 1. FIG. 5 shows the crosstalk effect ratios when a mirror surface is provided on the wall surface of the housing 9, when large, medium, and small wrinkles are provided on the wall surface of the housing 9, when vertical grooves with a rectangular cross section are provided, and when V-shaped grooves 91 are provided. As shown in FIG. 5, when the V-shaped grooves 91 are provided on the wall surface of the housing 9, the crosstalk effect ratio is reduced compared to other cases.

It suffices if the grooves 91 to be provided on the wall surface of the housing 9 are provided at least in a region of the wall surface of the housing 9 which faces the light source 7, which is a region of a portion that causes the reflected light to reach the light entering surface of the lens array 6 when the light is assumed to be specularly reflected by the wall surface of the housing 9. For example, in reference numeral 301 of (a) of FIG. 3, when the light passing through the optical path 74 is specularly reflected by the left wall surface 9L of the housing 9 and thereby reaches the right end of the lens array 6, the grooves 91 may be provided at least in a groove forming region 92 that ranges from the position where the light passing through the optical path 74 is incident on the left wall surface 9L to the light entering surface of the lens array 6.

### 2. Configuration Example

FIG. 6 is a block diagram of the display system 1 according to this embodiment. As shown in FIG. 6, the display system 1 includes the image display part 10 which is the display switching apparatus according to this embodiment, an input device 50, and a controller 60. The input device 50 is, for example, a shift lever, a wiper switch, or the like of the vehicle in which the display system 1 is installed. The vehicle in which the display system 1 is installed has a plurality of modes, and the driver operates the input device 50 to select a desired mode from the plurality of modes. For example, when the input device 50 is a shift lever, a desired mode is selected from a plurality of modes provided by the transmission of the engine of the vehicle. The controller 60 controls the operation of the image display part 10. In the display system 1, the image display part 10 displays an image indicating the mode selected in the driving device of the vehicle under the control of the controller 60. For example, when the input device 50 is a shift lever and the driver moves the input device 50 to the position of parking, the image display part 10 displays an image indicating parking.

### (Basic Configuration of the Display Switching Apparatus)

FIG. 7 is a schematic view showing the basic configuration of the image display part 10 according to this embodiment. As shown in FIG. 7, the image display part 10 includes a light absorbing member 2, a light diffusing member 3, a display condensing part 46, a plurality of light sources 7, and a substrate 8 to which the plurality of light sources 7 are attached, in order from top to bottom in the drawing.

The light absorbing member 2, the light diffusing member 3, a display part 45, and the lens array 6 are supported by the housing 9. Further, the basic configuration of the image display part 10 is formed by attaching the housing 9 to the substrate 8 to which the plurality of light sources 7 are attached. Moreover, the image display part 10 may include a protective layer for preventing damage above the light absorbing member 2. The size of each member described above can be appropriately designed according to the size of the region where the image display part 10 displays an image.

The light absorbing member 2 is a member that absorbs light, and the light diffusing member 3 is a member that diffuses light. That is, the light absorbing member 2 and the light diffusing member 3 can be collectively called a light control member. Configuration examples of the light control member include, for example, a smoked member, a half mirror, a polarizing plate, a color plate, a diffusing plate, a member for displaying a display image, a smoked member combined with a diffusing plate to have a diffusion function, etc.

The display condensing part 46 includes the display part 45 and the lens array 6. The display part 45 includes an image layer 4 and a matrix layer 5, and displays an image (display image) P to be displayed. The matrix layer 5 includes, for example, a pixel region 45a (opening, hereinafter the same) and a pixel surrounding region 45b (mask, hereinafter the same) which is a region other than the pixel region 45a. The image layer 4 and the matrix layer 5 are bonded together. The term “pixel surrounding region 45b” used herein refers to a region having a constant transmittance around each pixel region 45a. In addition, the pixel surrounding region 45b blocks light from the light source side, that is, light from the side where the lens array 6 is arranged.

As shown in FIG. 7, the lens array 6 provided below the display part 45 condenses the lights emitted by the plurality of light sources 7 attached to the substrate 8. The lens array 6 is configured by arranging a plurality of lenses.

The display part 45 includes a plurality of pixel regions 45a arranged to include regions, through which a light formed by condensing each of the lights emitted from the positions of the plurality of light sources 7 with each of the lenses of the lens array 6 passes, and the transmittance in each of the pixel regions 45a is set corresponding to a predetermined static pattern.

The shape of the display part 45 as viewed from the direction perpendicular to the display surface of the display part 45 is the same as or similar to the shape of the lens array 6 as viewed from the direction perpendicular to the display surface. For example, when the shape of the lens array 6 as viewed from the direction perpendicular to the display surface is a star shape indicated by reference numeral 101 in (a) of FIG. 1, the shape of the display part 45 as viewed from the direction perpendicular to the display surface is also a star shape.

The housing 9 holds the display part 45 and the lens array 6 on the inner side. The shape of the housing 9 as viewed from the direction perpendicular to the display surface is similar to but larger than the shape of the display part 45 as viewed from the direction perpendicular to the display surface thereof.

The plurality of light sources 7 may be RGBLEDs (red-green-blue light emitting diodes), for example.

With the configuration as described above, the image display part 10 is capable of switching the display images by switching the irradiation of lights from the plurality of light sources 7. The switching between on and off of the light source 7 is performed by a light emitting controller 11 as shown in FIG. 6.

### (Configuration Example of the Lens Array)

(a), (b), and (c) of FIG. 8 which are denoted by reference numeral 801, reference numeral 802, and reference numeral 803 are views showing a configuration example of the lens array 6 in FIG. 7, respectively. Specifically, as shown in the view indicated by reference numeral 801 in (a) of FIG. 8, the lens array 6 is configured by arranging a plurality of lenses in a two-dimensional matrix.

(b) of FIG. 8 which is denoted by reference numeral 802 is a perspective view showing an enlarged part of the lens array 6, and (c) of FIG. 8 which is denoted by reference numeral 803 is a partial cross-sectional view showing an enlarged part of the lens array 6.

FIG. 9 is a diagram showing an example of the state of the lens array 6 condensing lights. From FIG. 9, it can be understood that the light condensing point can be changed by changing the position of the light source.

FIG. 10 is a diagram in which the views denoted by reference numeral 1001, reference numeral 1002, reference numeral 1003, and reference numeral 1004 show a switching display example of the display part 45, respectively. The view indicated by reference numeral 1001 in FIG. 10 is a display example displayed on the display part 45 (image layer 4), the view indicated by reference numeral 1002 is an example of the displayed pattern, the view indicated by reference numeral 1003 is an enlarged view of the part Ain the view indicated by reference numeral 1001, and the view indicated by reference numeral 1004 is an enlarged view of the part B in the view indicated by reference numeral 1003.

In the display example shown in FIG. 10, for example, an image P5 (in the example, the hiragana character “ [symbol] ”), an image P6 (in the example, the pattern “Δ”), an image P7 (in the example, the uppercase alphabet “G”), and an image P8 (in the example, the number “6”) can be switched and displayed on the same image layer.

As shown by reference numeral 1004 in FIG. 10, as an example, it is possible to switch the display by dividing the entire display part 45 into a plurality of sections (a plurality of pixels) so that one section includes a maximum of four pixel regions 45a. Further, as shown by reference numeral 1004 in FIG. 10, the region other than the pixel region 45a of the display part 45 is the pixel surrounding region 45b.

FIG. 11 is a view showing the correspondence relationship between the display part 45, the lenses constituting the lens array 6, and the light sources 7. In FIG. 11, two pixels are illustrated, and the light from each light source is condensed by the lens array 6 and emitted from the corresponding pixel region 45a. Each pixel of the display part 45 is divided into the pixel region 45a and the pixel surrounding region 45b.

By using the display switching apparatus as described above as the image display part 10, an image indicating the selected mode can be displayed without using a complicated and expensive display device such as a liquid crystal display, thereby realizing the image display part 10 at a low cost.

The image display part 10 in this embodiment (1) displays the image P5 by emitting a light from the light source 7a, (2) displays the image P6 by emitting a light from the light source 7b, (3) displays the image P7 by emitting a light from the light source 7c, and (4) displays the image P8 by emitting a light from the light source 7d. That is, the image display part 10 is capable of switching and displaying a plurality of images P5 to P8 according to the operation of the input device 50, and is capable of switching and displaying a plurality of images P5 to P8 by switching between the light sources 7a to 7d to emit lights.

### 3. Modified Example

Although the embodiment of the disclosure has been described in detail above, the above description is merely an example of the disclosure in every respect. It goes without saying that various improvements and modifications can be made without departing from the scope of the disclosure. For example, the following changes are possible. Hereinafter, the same reference numeral is used for the same component as in the above embodiment, and the description is omitted as appropriate for the same points as in the above embodiment. The following modified examples may be combined as appropriate.

In the image display part 10 which is the display switching apparatus according to the first embodiment, the lens array 6, the housing 9, and the display part 45 are star-shaped as viewed from the direction perpendicular to the display surface of the display part 45. However, the lens array 6, the housing 9, and the display part 45 are not necessarily star-shaped as viewed from the direction perpendicular to the display surface of the display part 45.

(a) to (d) of FIG. 12 are views showing examples of the shape of the display part 45 as viewed from the direction perpendicular to the display surface of the display part 45. Reference numeral 1201 in (a) of FIG. 12 shows a display part 45C having a circular shape as viewed from the display surface in the vertical direction. In addition, reference numeral 1202 in (b) of FIG. 12 shows a display part 45D having a triangular shape as viewed from the display surface in the vertical direction. Reference numeral 1203 in (c) of FIG. 12 shows a display part 45E having a lightning bolt shape as viewed from the display surface in the vertical direction.

When the display part 45 has a circular shape, a triangular shape, or a lightning bolt shape as viewed from the direction perpendicular to the display surface, the lens array 6 also has a circular shape, a triangular shape, or a lightning bolt shape as viewed from the direction perpendicular to the display surface. In addition, when the display part 45 has a circular shape, a triangular shape, or a lightning bolt shape as viewed from the direction perpendicular to the display surface, the housing 9 also has a circular shape, a triangular shape, or a lightning bolt shape as viewed from the direction perpendicular to the display surface.

In the image display part 10 which is the display switching apparatus according to the first embodiment, the shape of the housing 9 as viewed from the direction perpendicular to the display surface of the display part 45 is assumed to be similar to the shapes of the display part 45 and the lens array 6 as viewed from the direction perpendicular to the display surface. However, if the shape of the housing 9 as viewed from the direction perpendicular to the display surface of the display part 45 is a shape that includes the shapes of the display part 45 and the lens array 6 as viewed from the direction perpendicular to the display surface, they may have a relationship other than similarity. For example, the outline shape of the housing 9 as viewed from the direction perpendicular to the display surface of the display part 45 may be the same as the outline shapes of the display part 45 and the lens array 6 as viewed from the direction perpendicular to the display surface.

Furthermore, the switching display example of the display part 45 is not limited to the images P5 to P8 shown in FIG. 10. For example, images P9 to P12 as shown by reference numeral 1204 in (d) of FIG. 12 may be displayed.

In the display switching apparatus according to the first embodiment, the wall surface of the housing 9 is shaped so that the wall surface of the housing 9 does not exist between the light sources 7 and the light entering surface 6a of the lenses that constitute the lens array 6. However, if there are lenses that are not used for image display among the lenses constituting the lens array 6, the wall surface of the housing 9 may exist between the light entering surface 6a of the lenses and the light sources 7. That is, the wall surface of the housing 9 is shaped so that the wall surface of the housing 9 does not exist between the plurality of light sources 7 and the light entering surface 6a of the lenses actually used for display on the display part 45 among the lenses that constitute the lens array 6.

### 4. Application Example

In the embodiment described so far, the display system of the disclosure is applied to a shift lever or a wiper switch, but the display system of the disclosure is also applicable to other driving devices of the vehicle.

For example, the display system of the disclosure is applicable to a dial-type system for selecting the operating mode of the transmission.

In addition, the display system of the disclosure is applicable to a switch (also referred to as a steering switch) provided on a handle (steering wheel).

Furthermore, the display system of the disclosure is applicable to an operation panel for rear seats. The operation panel may be, for example, capable of controlling the air conditioning of the vehicle and selecting the operation of the audio, which allows the passenger in the rear seat to control a part of the driving device of the vehicle.

Besides, the display system of the disclosure is applicable to a so-called push start switch that controls on/off of the power of the engine. In this case, the color of the image displayed when the power of the engine is off and the driver is braking the vehicle and when the power of the engine is off and the driver is not braking the vehicle may be changed.

Further, the display system of the disclosure is applicable to an instrument panel. For example, the display system of the disclosure may be applied to a winker or alert display displayed on the instrument panel.

In addition, the display system of the disclosure is applicable to a light switch that controls the operation of the headlight of the vehicle.

Moreover, the display system of the disclosure is applicable to a heater control switch that controls the operation of the heater of the vehicle.

The display system of the disclosure is also applicable to a welfare vehicle. Here, the welfare vehicle is, for example, a welfare vehicle that transports a wheelchair with a person sitting thereon. In such a welfare vehicle, there are many switches such as a switch for moving the wheelchair into the vehicle, such as a vehicle height adjustment switch, a safety belt switch, and a fixing device switch for fixing the wheelchair. Also, some switches require multiple operations such as “pull,” “push,” and “long press.” Therefore, there arises a problem that it is difficult to know how to operate each switch of the welfare vehicle. By applying the display system of the disclosure to each switch of such a welfare vehicle, it is easy for the operator of the welfare vehicle to recognize which mode is currently selected, thereby reducing the risk of malfunction.

The disclosure is not limited to the above-described embodiments, and it is possible to make various changes within the scope defined by the claims. Embodiments obtained by appropriately combining technical means disclosed in different embodiments are also included in the technical scope of the disclosure.

### Summary

The display switching apparatus according to aspect 1 of the disclosure is a display switching apparatus for switching display images by switching irradiation of lights from a plurality of light sources. The display switching apparatus includes: a lens array in which a plurality of lenses are arranged; a display part which includes a plurality of pixel regions arranged to include regions through which a light formed by condensing each of the lights emitted from the plurality of light sources with each of the lenses of the lens array passes; and a housing which holds the display part. A transmittance in each of the pixel regions is set corresponding to a predetermined static pattern, a shape of the display part as viewed in a direction perpendicular to a display surface of the display part is an irregular shape that is not rectangular, and a shape of the housing when viewed in the direction perpendicular to the display surface is the same as or similar to the shape of the display part as viewed in the direction perpendicular to the display surface.

The display switching apparatus according to aspect 2 of the disclosure may have a configuration that, in the display switching apparatus according to aspect 1, a wall surface of the housing is shaped so that the wall surface of the housing does not exist between the plurality of light sources and a light entering surface of an actually used lens used for display on the display part among the lenses constituting the lens array.

The display switching apparatus according to aspect 3 of the disclosure may have a configuration that, in the display switching apparatus according to aspect 1 or 2, a groove forming region including a plurality of grooves is provided in at least a portion of a region, which faces the light sources, on the wall surface of the housing.

The display switching apparatus according to aspect 4 of the disclosure is a display switching apparatus for switching display images by switching irradiation of lights from a plurality of light sources. The display switching apparatus includes: a lens array in which a plurality of lenses are arranged; a display part which includes a plurality of pixel regions arranged to include regions through which a light formed by condensing each of the lights emitted from the plurality of light sources with each of the lenses of the lens array passes; and a housing which holds the display part. A transmittance in each of the pixel regions is set corresponding to a predetermined static pattern, and a groove forming region including a plurality of grooves is provided in at least a portion of a region, which faces the light sources, on a wall surface of the housing.

The display switching apparatus according to aspect 5 of the disclosure may have a configuration that, in the display switching apparatus according to aspect 3 or 4, the grooves in the groove forming region extend in a direction parallel to an optical axis of the lens array from the light sources.

The display switching apparatus according to aspect 6 of the disclosure may have a configuration that, in the display switching apparatus according to aspect 3 or 4, the groove forming region is provided in a region, on the wall surface of the housing, which allows a light emitted from the light source to reach a light entering surface of an actually used lens used for display on the display part among the lenses constituting the lens array, assuming that the light is specularly reflected by the wall surface.

The display system according to aspect 7 of the disclosure is a display system installed inside a vehicle. The display system includes: an image display part which displays an image indicating a mode selected in a driving device of the vehicle that has a plurality of modes. The image display part includes the display switching apparatus according to aspect 1 or 4.

What is claimed is:

1. A display switching apparatus for switching display images by switching irradiation of lights from a plurality of light sources, the display switching apparatus comprising:
a lens array in which a plurality of lenses are arranged;
a display part which comprises a plurality of pixel regions arranged to include regions through which a light formed by condensing each of the lights emitted from the plurality of light sources with each of the lenses of the lens array passes; and
a housing which holds the display part,
wherein a transmittance in each of the pixel regions is set corresponding to a predetermined static pattern,
a shape of the display part as viewed in a direction perpendicular to a display surface of the display part is an irregular shape that is not rectangular, and
a shape of the housing when viewed in the direction perpendicular to the display surface is the same as or similar to the shape of the display part as viewed in the direction perpendicular to the display surface.

2. The display switching apparatus according to claim 1, wherein a wall surface of the housing is shaped so that the wall surface of the housing does not exist between the plurality of light sources and a light entering surface of an actually used lens used for display on the display part among the lenses constituting the lens array.

3. The display switching apparatus according to claim 1, wherein a groove forming region comprising a plurality of grooves is provided in at least a portion of a region, which faces the light sources, on the wall surface of the housing.

4. The display switching apparatus according to claim 3, wherein the grooves in the groove forming region extend in a direction parallel to an optical axis of the lens array from the light sources.

5. The display switching apparatus according to claim 3, wherein the groove forming region is provided in a region, on the wall surface of the housing, which allows a light emitted from the light source to reach a light entering surface of an actually used lens used for display on the display part among the lenses constituting the lens array, assuming that the light is specularly reflected by the wall surface.

6. A display system installed inside a vehicle, the display system comprising:
an image display part which displays an image indicating a mode selected in a driving device of the vehicle that has a plurality of modes,
wherein the image display part comprises the display switching apparatus according to claim 1.

7. A display switching apparatus for switching display images by switching irradiation of lights from a plurality of light sources, the display switching apparatus comprising:
a lens array in which a plurality of lenses are arranged;
a display part which comprises a plurality of pixel regions arranged to include regions through which a light formed by condensing each of the lights emitted from the plurality of light sources with each of the lenses of the lens array passes; and
a housing which holds the display part,
wherein a transmittance in each of the pixel regions is set corresponding to a predetermined static pattern, and
a groove forming region comprising a plurality of grooves is provided in at least a portion of a region, which faces the light sources, on a wall surface of the housing.

8. The display switching apparatus according to claim 7, wherein the grooves in the groove forming region extend in a direction parallel to an optical axis of the lens array from the light sources.

9. The display switching apparatus according to claim 7, wherein the groove forming region is provided in a region, on the wall surface of the housing, which allows a light emitted from the light source to reach a light entering surface of an actually used lens used for display on the display part among the lenses constituting the lens array, assuming that the light is specularly reflected by the wall surface.

10. A display system installed inside a vehicle, the display system comprising:
an image display part which displays an image indicating a mode selected in a driving device of the vehicle that has a plurality of modes,
wherein the image display part comprises the display switching apparatus according to claim 7.
